(19) United States
(12) Patent Application Publication
(10) Pub. No.: US 2015/0240863 A1
(43) Pub. Date: Aug. 27, 2015

(54) Microstructure Sucker Device and Operation Method Thereof

(71) Applicants: National University of Kaohsiung, Kaohsiung (TW); Biomimedtech Co., Ltd., Kaohsiung (TW)

(72) Inventors: Yi-Chang Chung, Kaohsiung (TW); Wang-Yi Chang, Kaohsiung (TW); Yi-Hong Chiu, Kaohsiung (TW)

(21) Appl. No.: 14/587,059

(22) Filed: Dec. 31, 2014

Related U.S. Application Data
(63) Continuation-in-part of application No. 14/275,991, filed on May 13, 2014.

(30) Foreign Application Priority Data
Feb. 24, 2014 (TW) 103105983
May 30, 2014 (TW) 103119083

(51) Int. Cl. F16B 47/00; F16M 13/02; B29C 59/02; A44B 18/00

(52) U.S. Cl. CPC F16B 47/00; A44B 18/0053; F16B 47/003; F16M 13/022; B29C 59/022; B29C 2059/023

(57) ABSTRACT

A microstructure sucker device includes a substrate, a microstructure and an operation surface. The microstructure is arranged on the first surface of the substrate to form a microstructure sucker layer. The operation surface is provided on the second surface of the substrate and corresponds to the surface sucker layer. An operation method of the microstructure sucker device includes: aligning the sucker layer with a predetermined surface; attaching the microstructure sucker layer to the predetermined surface; pressing the microstructure sucker layer to discharge an amount of air from the microstructure sucker layer to suck the predetermined surface; pulling an edge of the microstructure sucker layer to separate the microstructure sucker layer from the predetermined surface.

### CROSS REFERENCE TO RELATED APPLICATIONS

This application is a continuation-in-part of U.S. patent application Ser. No. 14/275,991, filed May 23, 2014, which is hereby incorporated by reference in its entirety.

### BACKGROUND OF THE INVENTION

1. Field of the Invention

The present invention relates to a microstructure sucker device and operation method thereof. Particularly, the present invention relates to a micro-scaled or nano-scaled microstructure sucker device and operation method thereof. More particularly, the present invention relates to an adhesive-free microstructure sucker device and operation method thereof.

2. Description of the Related Art

By way of example, Taiwanese Pat. Publication No. 1263513, entitled “Biomedical Implant Having Sucker-Type Nano-Scaled Cavities and Manufacturing Method Thereof,” discloses a biomedical implant member. The biomedical implant member includes a plurality of sucker-type nano-scaled cavities. A sucker-type nano-scaled cavity structure is provided on a part or whole surface of the biomedical implant member. The sucker-type nano-scaled cavity structure is formed from a plurality of nano-scaled tubes.

A part or the whole of the nano-scaled tubes are arranged to form an array and each of the nano-scaled tubes contains a bioabsorbable material or medical material. Each size of the nano-scaled tubes essentially ranges between 10 nm and 100 nm. In addition, the biomedical implant member is selectively made of pure titanium or titanium alloy.

The manufacturing method of the biomedical implant member includes: (a) anodizing the biomedical implant member in a treatment solution with adding a solvent to form an anodic oxide film on the surface of the biomedical implant member; (b) treating the surface of the biomedical implant member with an externally applied voltage to form the nano-scaled tubes which has the nano-scaled cavities.

In anodizing the biomedical implant member, the solvent is selected from hydrofluoric acid, sulfuric acid or the like. Furthermore, in treating the surface of the biomedical implant member, the externally applied voltage is selectively not greater than 50 V.

However, the biomedical implant member with the nano-scaled cavities is only suitable for sucking the bioabsorbable materials or medical materials in biomedical implant operation and unsuitable for sucking an ordinary weight object which may damage the structure of the nano-scaled cavities in operation. Furthermore, it is complicated in forming the nano-scaled cavities on the biomedical implant member. Hence, there is a need of providing a microstructure sucker device. The above-mentioned patent is incorporated herein by reference for purposes including, but not limited to, indicating the background of the present invention and illustrating the situation of the art.

As is described in greater detail below, the present invention provides a microstructure sucker device, a manufacturing method thereof and an operation method thereof. A microstructure is provided to form a microstructure sucker layer on a sucker substrate which provides an operation surface to align with the microstructure sucker layer. The operation surface is pressed to operate the microstructure sucker layer to suck a weight object in such a way as to mitigate and overcome the above problem.

### SUMMARY OF THE INVENTION

The primary objective of this invention is to provide a microstructure sucker device, a manufacturing method thereof and an operation method thereof. A microstructure is provided to form a microstructure sucker layer on a sucker substrate which provides an operation surface to align with the microstructure sucker layer. The operation surface is pressed to operate the microstructure sucker layer to suck a weight object. Advantageously, the microstructure sucker device, manufacturing method and operation method of the present invention is successful in sucking and releasing the weight object.

The microstructure sucker device in accordance with an aspect of the present invention includes:

a sucker substrate including a first surface and a second surface;

at least one microstructure provided to form a microstructure sucker layer on the first surface of the sucker substrate; and

an operation surface provided on the second surface of the sucker substrate corresponding to the microstructure sucker layer;

wherein at least one portion of the microstructure sucker layer is attached to a predetermined surface and at least one portion of the operation surface is pressed to deform the microstructure sucker layer for forcibly releasing at least one amount of air from the at least one microstructure, thereby sucking the predetermined surface.

In a separate aspect of the present invention, the microstructure is formed with a concave-convex structure, an inclined groove structure, a groove set, a recession set, a cave set or a combination thereof.

In a further separate aspect of the present invention, the microstructure includes a first groove set and a second groove set intersecting to form an intersected array.

In yet a further separate aspect of the present invention, the microstructure has a nano-scaled structure or a micro-scaled structure.

In yet a further separate aspect of the present invention, the second surface of the sucker substrate further includes a hook, a ring hanger, a ring pull, a support arm or a support frame combined therewith by adhesive or twin adhesive member.

The microstructure sucker device in accordance with another aspect of the present invention includes:

a sucker substrate including a first surface and a second surface;

at least one microstructure provided to form a microstructure sucker layer on the first surface of the sucker substrate; and

an operation plate provided on the second surface of the sucker substrate corresponding to the microstructure sucker layer;

wherein at least one portion of the microstructure sucker layer is attached to a predetermined surface and at least one portion of the operation plate is pressed to deform the microstructure sucker layer for forcibly releasing at least one amount of air from the at least one microstructure, thereby sucking the predetermined surface.

In a separate aspect of the present invention, the operation plate is selected from a rubber plate or a resilient plate.

In a further separate aspect of the present invention, the operation plate further includes a hook, a ring hanger, a ring pull, a support arm or a support frame combined therewith by adhesive or twin adhesive member.

The operation method of the microstructure sucker device in accordance with an aspect of the present invention includes:

providing at least one microstructure to form a microstructure sucker layer correspondingly facing a predetermined surface of an object;

attaching at least one portion of the microstructure sucker layer to the predetermined surface of the object; and

pressing the microstructure sucker layer for forcibly releasing at least one amount of air from the at least one microstructure, thereby sucking the predetermined surface of the object.

In a separate aspect of the present invention, in separating operation, an edge of the microstructure sucker layer is pulled to start separating the microstructure sucker device from the predetermined surface of the object.

In a further separate aspect of the present invention, the microstructure sucker layer is operated to suck the predetermined surface of the object, thereby hanging the object in a vertical direction with respect to a plane of the microstructure sucker layer.

In yet a further separate aspect of the present invention, the microstructure sucker layer is operated to suck the predetermined surface of the object to thereby provide a shear force for hanging the object in a parallel direction with respect to a plane of the microstructure sucker layer.

The manufacturing method of the microstructure sucker device in accordance with an aspect of the present invention includes:

providing a sucker substrate, with the sucker substrate including a first surface and a second surface;

providing at least one shaping die, with the shaping die including at least one shaping microstructure surface;

correspondingly forming at least one microstructure on the first surface of the sucker substrate with the at least one shaping microstructure surface of the shaping die; and

separating the shaping die from the first surface of the sucker substrate to obtain a microstructure sucker layer thereof.

In a separate aspect of the present invention, a blank member is prefabricated to provide the sucker substrate for directly forming the at least one microstructure on the first surface thereof with the shaping die.

In a further separate aspect of the present invention, the at least one microstructure is formed by UV imprinting, thermal imprinting, transfer printing, molding or other mechanical extrusion with photo resist resins, thermosetting resins, macromolecule resins, plastics or thin-film materials.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded perspective view of a microstructure sucker device and a shaping die in accordance with a preferred embodiment of the present invention.

FIG. 2 is a block diagram of the manufacturing method of the microstructure sucker device in accordance with a preferred embodiment of the present invention.

FIGS. 3(a)-3(f) are a series of perspective views in manufacturing the microstructure sucker device in accordance with the preferred embodiment of the present invention.

FIG. 4 is a perspective view of a microstructure sucker device provided with an operation plate in accordance with another preferred embodiment of the present invention.

FIG. 5 is an exploded perspective view of the microstructure sucker device and a weight object in accordance with the preferred embodiment of the present invention in sucking operation.

FIG. 6 is a perspective view of the microstructure sucker device and the weight object in accordance with the preferred embodiment of the present invention in hanging operation.

FIGS. 7(a)-7(d) are a series of partial views of patterns of microstructures applied in the microstructure sucker device in accordance with the preferred embodiment of the present invention.

FIGS. 8(a)-8(e) are a series of side views of the microstructure sucker devices combined with various connection members in accordance with the preferred embodiment of the present invention.

FIG. 9 is a SEM view of a microstructure sucker layer formed on the microstructure sucker device in accordance with the preferred embodiment of the present invention.

FIG. 10 is another SEM view of the microstructure sucker layer formed on the microstructure sucker device in accordance with the preferred embodiment of the present invention.

### DETAILED DESCRIPTION OF THE INVENTION

It is noted that a microstructure sucker device, a manufacturing method thereof and an operation method thereof in accordance with the present invention can be applicable for sucking various products, including optical glass, LCD panels, solar cells, semiconductor elements, silicon wafers, 3C products, steel-protective films of building materials, ships and spare parts or other weight objects, for example. Additionally, the microstructure sucker device of the present invention is suitable for installing in various automatic, semi-automatic or non-automatic machines, including various robotic arms, various automatic or non-automatic conveyer or various clamping devices, for example, which are not limitative of the present invention.

Throughout the specification, unless the context requires otherwise, the term sucker, as used herein, provides a function of sucking any surface of an object or a similar function as one of ordinary skill commonly known in the art. The sucker or microstructure sucker device of the present invention can be applied to produce a protective film for attaching to an object surface, including an optical glass surface, a LCD panel surface, a solar cell surface, a semiconductor element (package) surface, a silicon wafer surface, for example.

FIG. 1 shows an exploded perspective view of a microstructure sucker device (upper portion in FIG. 1) and a shaping die (lower portion in FIG. 1) in accordance with a preferred embodiment of the present invention. Referring now to the upper portion in FIG. 1, the microstructure sucker device 1 of the preferred embodiment of the present invention includes a sucker substrate 10, a microstructure sucker layer 20 and an operation surface 30. The microstructure sucker layer 20 is selectively provided on a predetermined position of the sucker substrate 10, including a top surface, a bottom surface, sidewall surfaces or other suitable surfaces, for sucking a weight member or object.

With continued reference to the upper portion in FIG. 1, by way of example, the microstructure sucker device 1 has a predetermined thickness and predetermined dimensions. In a preferred embodiment, a shape of the microstructure sucker device 1 is formed from a flat board, a block or a circular plate or other pattern-shaped members. The microstructure sucker layer 20 and the operation surface 30 are suitably arranged on the sucker substrate 10 to form the microstructure sucker device 1.

With continued reference to the upper portion in FIG. 1, by way of example, the sucker substrate 10 includes a first surface 11 and a second surface 12. At least one predetermined sucking area of the microstructure sucker device 1 is designated on the first surface 11. In a preferred embodiment, the first surface 11 and the second surface 12 are provided on opposite sides of the microstructure sucker device 1.

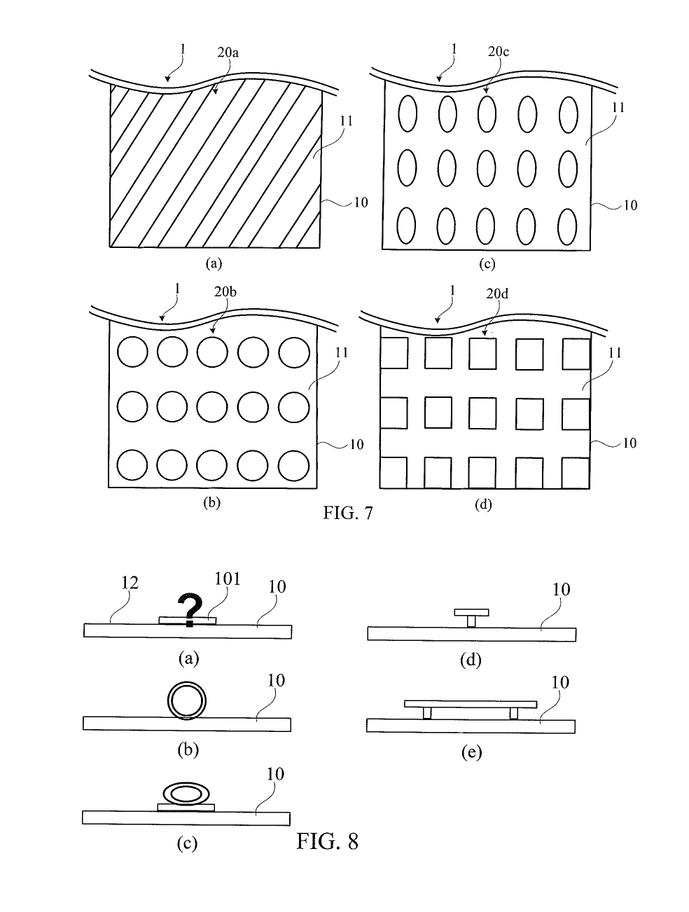

With continued reference to the upper portion in FIG. 1, by way of example, the microstructure sucker layer 20 includes microstructures having a nano-scaled structure or a micro-scaled structure. The microstructures are arranged in the predetermined sucking area in various manners, including equi-spaced arrangements, inclined arrangements, intersection arrangements or other suitable arrangements. In a preferred embodiment, the microstructures of the microstructure sucker layer 20 are formed with a concave-convex structure, an inclined groove structure, a groove set, a recession set, a cave set or a combination thereof, as best shown in FIGS. 7(a)-7(d). In a preferred embodiment, the microstructure includes a first groove set and a second groove set intersected each other to form an intersected array.

With continued reference to the upper portion in FIG. 1, by way of example, grooves of the microstructure sucker layer 20 are juxtaposed on the first surface 11 of the sucker substrate 10 to form a sucking layer or a sucking operation layer. Accordingly, the sucker substrate 10 is formed with a sucking surface (front surface of the sucking layer) and a combination surface (reverse surface of the sucking layer). The combination surface is applied to securely combine with a surface of other mechanical members.

Turning now to the lower portion in FIG. 1, a shaping die 5 is applied to manufacture the microstructure sucker device 1 of the preferred embodiment of the present invention and is made of suitable materials. By way of example, the shaping die 5 includes a plurality of shaping microstructures 51 with a predetermined pattern or design which corresponds to that of the microstructures of the microstructure sucker layer 20, as best shown in the upper portion of FIG. 1.

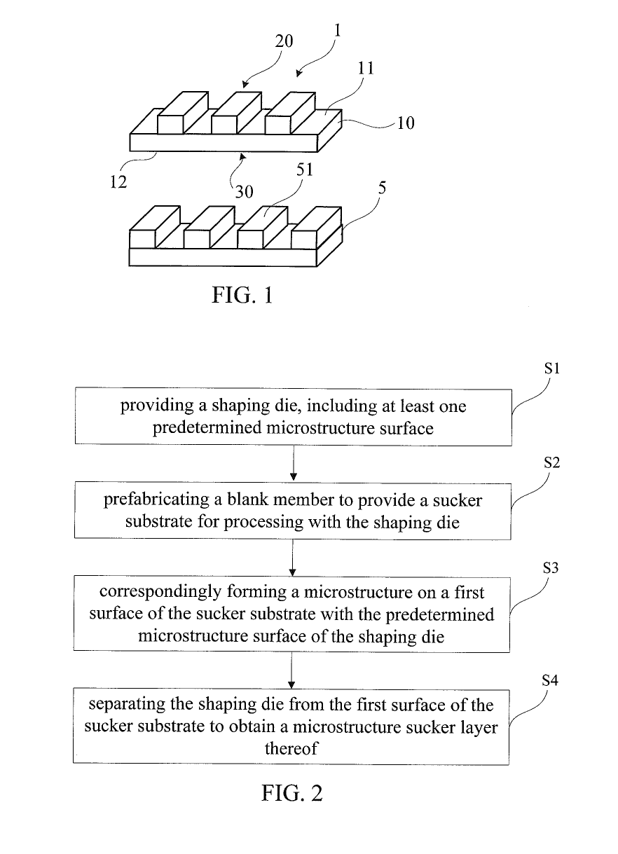

FIG. 2 shows a block diagram, corresponding to FIG. 1, of the manufacturing method of the microstructure sucker device in accordance with a preferred embodiment of the present invention. Referring now to FIGS. 1 and 2, the manufacturing method of the microstructure sucker device 1 includes the step S1: prefabricating at least one of the shaping dies 5 by suitable manners. The shaping die 5 includes at least one shaping microstructure surface formed with the shaping microstructures 51.

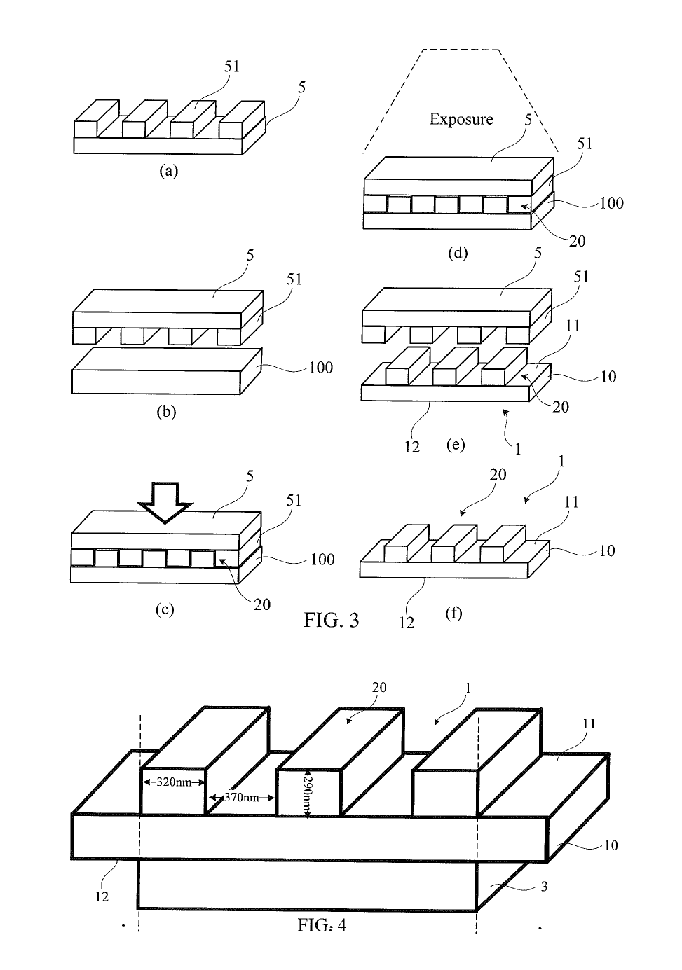

Still referring to FIGS. 1 and 2, the manufacturing method of the microstructure sucker device 1 further includes the step S2: subsequently, prefabricating at least one blank member 100, as best shown in FIG. 3(b), for providing the sucker substrate 10. The blank member 100 of the sucker substrate 10 is processed to form the microstructure sucker layer 20 by impression of the shaping microstructures 51 of the shaping die 5, as best shown in FIGS. 3(b) and 3(c), or other suitable manners.

Still referring to FIGS. 1 and 2, the manufacturing method of the microstructure sucker device 1 further includes the step S3: subsequently, pressing or repeatedly pressing and correspondingly forming at least one of the microstructures of the microstructure sucker layer 20 on the first surface 11 of the sucker substrate 10 with the at least one shaping microstructure surface of the shaping die 5.

Still referring to FIGS. 1 and 2, the manufacturing method of the microstructure sucker device 1 further includes the step S4: subsequently, after forming the microstructures of the microstructure sucker layer 20, peeling off or separating the shaping die 5 from the first surface 11 of the sucker substrate 10 to obtain a product of the shaped microstructure sucker layer 20 of the microstructure sucker device 1 which has a predetermined degree of flexibility.

FIGS. 3(a)-3(f) are a series of perspective views, corresponding to FIGS. 1 and 2, in manufacturing the microstructure sucker device in accordance with the preferred embodiment of the present invention. Referring now to FIGS. 1, 2 and 3(a), the manufacturing method of the microstructure sucker device 1 includes the step: securely presetting at least one or a plurality of the shaping dies 5 on a predetermined position of a machine (not shown) or a tool member, for example.

Turning now to FIGS. 1, 2 and 3(b), the manufacturing method of the microstructure sucker device 1 further includes the step: subsequently, aligning the shaping microstructures 51 of the shaping die 5 with the blank member 100 which is prefabricated to provide the sucker substrate 10. By way of example, the blank member 100 is made of a material selected from photo resist materials or other shapable fluid materials (i.e. gel material). An upper surface of the blank member 100 is pressed downward a predetermined distance by the shaping microstructures 51 of the shaping die 5 in a single pressing step or a series of pressing steps. In a preferred embodiment, the blank member 100 is provided or mounted on a workbench, a platform or the like.

Turning now to FIGS. 1, 2 and 3(c), the manufacturing method of the microstructure sucker device 1 further includes the step: subsequently, pressing or repeatedly the shaping microstructures 51 of the shaping die 5 tightly on the upper surface of the blank member 100. Advantageously, the microstructures of the microstructure sucker layer 20 are integrally formed by thermal imprinting or other mechanical extrusion. In pressing operation, the shapable fluid material is deformed and thus shaped into a series of gaps formed among the shaping microstructures 51 of the shaping die 5. Each of the gaps is formed between any two of ribs. In a preferred embodiment, the microstructures of the microstructure sucker layer 20 are also formed by transfer printing, molding or other forming manners.

Turning now to FIGS. 1, 2 and 3(d), the manufacturing method of the microstructure sucker device 1 further includes the step: subsequently, when the blank member 100 is made of a photo resist material or other suitable materials, the upper surface of the blank member 100 is exposed in designated light to harden the microstructures of the microstructure sucker layer 20 on the first surface 11 of the sucker substrate 10, as best shown in FIGS. 3(e) and 3(f).

Turning now to FIGS. 1, 2, 3(e) and 3(f), the manufacturing method of the microstructure sucker device 1 further includes the step: subsequently, after completely forming the microstructures of the microstructure sucker layer 20, peeling off or separating the shaping die 5 from the first surface L1 of the sucker substrate 10 in suitable manners, as best shown in FIG. 3(e). Consequently, the shaped microstructure sucker layer 20 of the microstructure sucker device 1 is completely separated and thus the flexible product thereof is obtained, as best shown in FIG. 3(f).

Referring again to the upper portion in FIG. 1, each groove of the microstructure sucker layer 20 has a sucking opening which communicates with an interior of the microstructure sucker layer 20. Accordingly, the grooves of the microstructure sucker layer 20 are capable of sucking or discharging air via the sucking openings. Formed between the grooves of the microstructure sucker layer 20 are upright walls with a predetermined thickness to isolate therebetween. The upright walls can reinforce the entire structure of the sucker substrate 10 so as to endure a high degree of mechanical deformation in sucking operation.

Still referring to the upper portion in FIG. 1, by way of example, in a preferred embodiment, each groove of the microstructure sucker layer 20 has a plurality of semi-open cavities which can respond to generate elastic deformation in sucking operation. The semi-open cavities are capable of containing a predetermined amount of various gases (e.g. air, nitrogen or other inert gases) for sucking operation. In operation, inner volumes of the semi-open cavities can be mechanically compressed to resiliently deform to thereby provide a function of sucking a surface of an object. Alternatively, the compressed inner volumes of the semi-open cavities can return to its original shapes to thereby provide a function of releasing the object.

With continued reference to the upper portion in FIG. 1, by way of example, the operation surface 30 is provided on the second surface 12 of the sucker substrate 10 and corresponds to the microstructure sucker layer 20 provided on the first surface 11 of the sucker substrate 10. In another embodiment, the operation surface 30 is provided on a suitable position of a reverse side (e.g. combination surface) of the microstructure sucker layer 20.

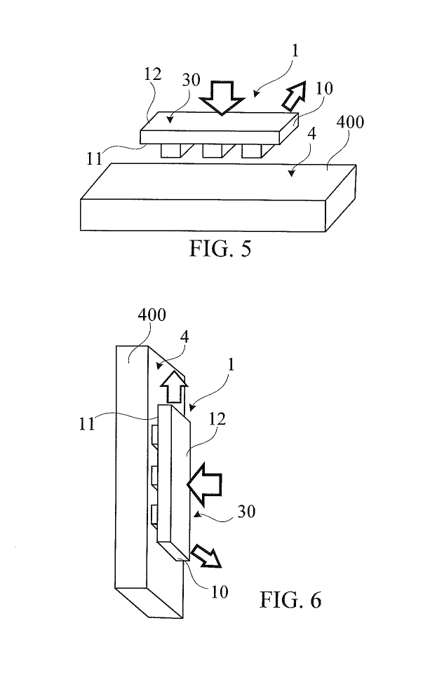

With continued reference to the upper portion in FIG. 1, by way of example, the microstructure sucker layer 20 of the microstructure sucker device 1 is attachable to a surface (as best shown in FIGS. 5 and 6) with a degree of smoothness and waterproof. When the operation surface 30 is pressed to compress the microstructure sucker layer 20 with a predetermined force, a suitable amount of air is discharged from the microstructure sucker layer 20 to thereby suck the surface of the object. Conversely, when a suitable amount of air is leaked into the compressed microstructure sucker layer 20, the microstructure sucker layer 20 will release the surface of the object.

With continued reference to the upper portion in FIG. 1, by way of example, according to different needs, the sucker substrate 10 further includes a hook, a ring hanger, a ring pull, a support arm or a support frame, as best shown in FIGS. 8(a)-8(e), or other suspension mechanisms to combine with the second surface 12 of the sucker substrate 10 by adhesive agent, twin adhesive member or other suitable manners.

FIG. 4 shows a perspective view, similar to FIG. 3(f), of a microstructure sucker device provided with an operation plate in accordance with another preferred embodiment of the present invention. Referring to FIG. 4, the microstructure sucker device 1 of the preferred embodiment of the present invention includes a sucker substrate 10, a microstructure sucker layer 20 and an operation plate 3. The microstructure sucker layer 20 has nano-scaled or micro-scaled grooves and ribs of the microstructures. By way of example, a height of the rib is 290 nm, a width of the rib is 320 and a width of the groove is 370 nm.

With continued reference to FIG. 4, by way of example, the operation plate 3 is selected from a flexible pad, a cushion, a flat plate or other plate-like members which has a predetermined thickness and dimensions. The operation plate 3 includes a first surface and a second surface arranged on opposite sides thereof. In a preferred embodiment, an area size of the operation plate 3 is identical with that of the microstructure sucker device 1 or is smaller or greater than that of the microstructure sucker device 1.

With continued reference to FIG. 4, by way of example, the operation plate 3 is formed from a rubber plate or a resilient plate made of rubber or other resilient materials. Furthermore, the operation plate 3 has at least two edges vertically aligned with two boundaries or edges of the microstructure of the microstructure sucker layer 20, as best shown at dotted lines in FIG. 4. The first surface of the operation plate 3 is attached to the second surface 12 of the sucker substrate 10 to thereby provide a preload thereon.

With continued reference to FIG. 4, by way of example, the first surface of the operation plate 3 is attached to the second surface 12 of the sucker substrate 10 by adhesive agent, mighty bond instant glue, twin adhesive member or other suitable manners. According to different needs, the operation plate 3 further includes a hook, a ring hanger, a ring pull, a support arm or a support frame, as best shown in FIGS. 8(a)-8(e), or other suspension mechanisms combined therewith by adhesive agent, twin adhesive member or other suitable manners.

FIG. 5 shows an exploded perspective view of the microstructure sucker device, depicted in FIG. 3(f), and a weight object in accordance with the preferred embodiment of the present invention in sucking operation. Referring now to FIGS. 3(f) and 5, the operation method of the microstructure sucker device 1 includes the step: in sucking operation, providing at least portion of the microstructure sucker layer 20 of the at least one microstructure sucker device 1 correspondingly facing a predetermined surface 4 of an object 400. The object 400 is provided on a workbench, a platform or the like, for example.

Turning now to FIG. 5, the operation method of the microstructure sucker device 1 further includes the step: attaching the at least one portion or the entire portion of the microstructure sucker layer 20 to the predetermined surface 4 of the object 400 suitable for automatically, semi-automatically or manually pressing the operation surface 30 of the microstructure sucker device 1 with suitable manners.

With continued reference to FIG. 5, the operation method of the microstructure sucker device 1 further includes the step: pressing the operation surface 30 (downward arrow in FIG. 5) to deform the microstructure sucker layer 20 for forcibly releasing or discharging at least one amount of air from the at least one microstructure of the microstructure sucker layer 20, thereby sucking the predetermined surface 4 of the object 400. By way of example, a part or entire amount of air contained in the grooves of the microstructure sucker layer 20 is discharged to provide a predetermined force to suck the predetermined surface 4 of the object 400. In use, the entire object 400 vertically hangs on a predetermined position or suspends in midair via the microstructure sucker device 1 in the vertical direction thereof. In an alternative embodiment, the object 400 hangs on the predetermined position or suspends in midair with respect to an oblique angle thereof.

With continued reference to FIG. 5, the operation method of the microstructure sucker device 1 further includes the step: in releasing operation, peeling off or pulling at least one portion of an edge (e. g. right or left edge) of the microstructure sucker layer 20 to start separating at least one part (grooves) of the microstructures of the microstructure sucker device 1 from the predetermined surface 4 of the object 400 in the beginning. Subsequently, the microstructure sucker device 1 is further gradually separated along a horizontal direction of the predetermined surface 4 of the object 400, as shown at upward arrow in FIG. 5, for complete separation.

FIG. 6 shows a perspective view, similar to FIG. 5, of the microstructure sucker device and the weight object in accordance with the preferred embodiment of the present invention in another type of hanging operation. Referring now to FIG. 6, the microstructure sucker layer 20 is operated to suck the predetermined surface 4 of the object 400 to thereby provide a shear force, as shown at upward arrow in FIG. 6, in a parallel direction with respect to a plane of the microstructure sucker layer 20. Accordingly, an edge of the object 400 hangs on a predetermined position or suspends in midair via the shear force provided by the microstructure sucker device 1.

With continued reference to FIG. 6, in releasing operation, peeling off or pulling at least one portion of an edge (e. g. top or bottom edge) of the microstructure sucker layer 20 to start separating at least one part (grooves) of the microstructures of the microstructure sucker device 1 from the predetermined surface 4 of the object 400 in the beginning. Subsequently, the microstructure sucker device 1 is further gradually separated along a vertical direction of the predetermined surface 4 of the object 400, as best shown at upward arrow in FIG. 5, for complete separation.

FIGS. 7(a)-7(d) show a series of partial views of patterns of microstructures applied in the microstructure sucker device in accordance with the preferred embodiment of the present invention corresponding to FIG. 3(f). Referring now to FIG. 7(a), a first pattern of the microstructures 20a includes a plurality of inclined grooves which are equi-spaced or variably spaced. The inclined grooves are parallel each other and extend on the first surface 11 of the microstructure sucker device 1.

Turning now to FIG. 7(b), a second pattern of the microstructures 20b includes a plurality of circular convexes or concaves which are equi-spaced or variably spaced to form a circular convex array or a circular concave array. In a preferred embodiment, the circular convexes and concaves are combined to form a concave-convex array. The circular convex array or the circular concave array is arranged in order on the first surface 11 of the microstructure sucker device 1.

Turning now to FIG. 7(c), a third pattern of the microstructures 20c includes a plurality of oval convexes or concaves which are equi-spaced or variably spaced to form an oval convex array or an oval concave array. In a preferred embodiment, the oval convexes and concaves are combined to form another concave-convex array. The oval convex array or the oval concave array is arranged in order on the first surface 11 of the microstructure sucker device 1.

Turning now to FIG. 7(d), a fourth pattern of the microstructures 20d includes a plurality of first grooves and a plurality of second grooves intersecting to form a right-angle intersected array.

FIGS. 8(a)-8(e) show a series of side views of the microstructure sucker devices combined with various connection members in accordance with the preferred embodiment of the present invention. Referring now to FIG. 8(a), the second surface 12 of the sucker substrate 10 further includes a hook combined therewith by an adhesive layer or a twin adhesive member 101. The second surface 12 of the sucker substrate 10 further includes a ring hanger as shown in FIG. 8(b), a ring pull as shown in FIG. 8(c), a support arm as shown in FIG. 8(d) and a support frame as shown in FIG. 8(e).

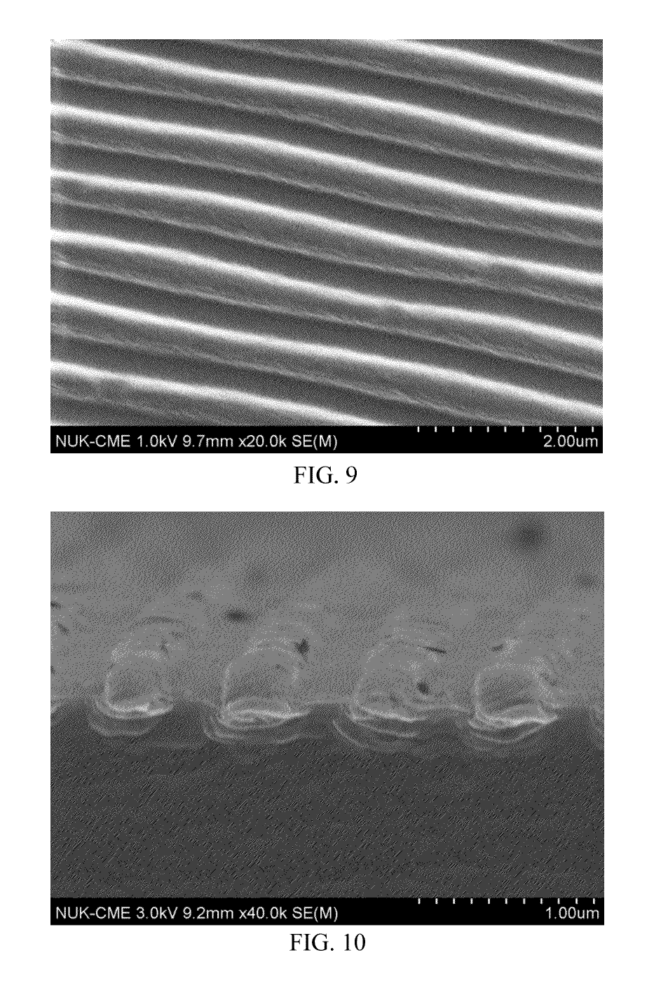

FIG. 9 shows a SEM view of a microstructure sucker layer formed on the microstructure sucker device in accordance with the preferred embodiment of the present invention corresponding to FIG. 3(f). FIG. 10 shows another SEM view, similar to FIG. 9, of the microstructure sucker layer formed on the microstructure sucker device in accordance with the preferred embodiment of the present invention.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A microstructure sucker device comprising:
a sucker substrate including a first surface and a second surface;
at least one microstructure provided to form a microstructure sucker layer on the first surface of the sucker substrate; and
an operation surface provided on the second surface of the sucker substrate corresponding to the microstructure sucker layer;
wherein at least one portion of the microstructure sucker layer is attached to a predetermined surface and at least one portion of the operation surface is pressed to deform the microstructure sucker layer for forcibly releasing at least one amount of air from the at least one microstructure, thereby sucking the predetermined surface.

2. The microstructure sucker device as defined in claim 1, wherein the microstructure is formed with an intersected array including a first groove set and a second groove set intersected each other, a concave-convex structure, an inclined groove structure, a groove set, a recession set, a cave set or a combination thereof.

3. The microstructure sucker device as defined in claim 1, wherein the sucker substrate provided with the microstructure sucker layer is applied to produce a protective film.

4. The microstructure sucker device as defined in claim 1, wherein the microstructure has a nano-scaled structure or a micro-scaled structure.

5. The microstructure sucker device as defined in claim 1, wherein the second surface of the sucker substrate further includes a hook, a ring hanger, a ring pull, a support arm or a support frame combined therewith.

6. The microstructure sucker device as defined in claim 5, wherein the second surface of the sucker substrate is combined with the hook, the ring hanger, the ring pull, the support arm or the support frame by adhesive or a twin adhesive member.

7. The microstructure sucker device as defined in claim 1, wherein an operation plate provided on the second surface of the sucker substrate corresponding to the microstructure sucker layer and at least one portion of the operation plate is pressed to deform the microstructure sucker layer for forcibly releasing at least one amount of air from the at least one microstructure, thereby sucking the predetermined surface.

8. The microstructure sucker device as defined in claim 7, wherein the operation plate is selected from a rubber plate or a resilient plate.

9. The microstructure sucker device as defined in claim 7, wherein the operation plate further includes a hook, a ring hanger, a ring pull, a support arm or a support frame.

10. The microstructure sucker device as defined in claim 9, wherein the operation plate is combined with the hook, the ring hanger, the ring pull, the support arm or the support frame by adhesive or a twin adhesive member.

11. The microstructure sucker device as defined in claim 7, wherein an area size of the operation plate is identical with that of the microstructure sucker device.

12. The microstructure sucker device as defined in claim 7, wherein an area size of the operation plate is smaller or greater than that of the microstructure sucker device.

13. An operation method of a microstructure sucker device comprising:
providing at least one microstructure to form a microstructure sucker layer correspondingly facing a predetermined surface of an object;
attaching at least one portion of the microstructure sucker layer to the predetermined surface of the object; and
pressing the microstructure sucker layer for forcibly releasing at least one amount of air from the at least one microstructure, thereby sucking the predetermined surface of the object.

14. The operation method as defined in claim 13, wherein, in separating operation, an edge of the microstructure sucker layer is pulled to start separating the microstructure sucker device from the predetermined surface of the object.

15. The operation method as defined in claim 13, wherein the microstructure sucker layer is operated to suck the predetermined surface of the object, thereby hanging the object in a vertical direction with respect to a plane of the microstructure sucker layer.

16. The operation method as defined in claim 13, wherein the microstructure sucker layer is operated to suck the predetermined surface of the object to thereby provide a shear force for hanging the object in a parallel direction with respect to a plane of the microstructure sucker layer.

17. A manufacturing method of a microstructure sucker device comprising:
providing a sucker substrate, with the sucker substrate including a first surface and a second surface;
providing at least one shaping die, with the shaping die including at least one shaping microstructure surface;
correspondingly forming at least one microstructure on the first surface of the sucker substrate with the at least one shaping microstructure surface of the shaping die; and
separating the shaping die from the first surface of the sucker substrate to obtain a microstructure sucker layer thereof.

18. The manufacturing method as defined in claim 17, wherein a blank member is prefabricated to provide the sucker substrate for directly forming the at least one microstructure on the first surface thereof with the shaping die.

19. The manufacturing method as defined in claim 17, wherein the at least one microstructure is formed by UV imprinting, thermal imprinting, transfer printing, molding or other mechanical extrusion.

20. The manufacturing method as defined in claim 17, wherein the sucker substrate is made of a photo resist material, a thermosetting material, a macromolecule material, a plastic material or a thin film material.
